(19) United States
(12) Patent Application Publication
(10) Pub. No.: US 2004/0083897 A1
(43) Pub. Date: May 6, 2004

(54) Instant coffee-brewing container for preparing freshly brewed coffee

(76) Inventor: Myeong Jin Park, Seoul (KR)

Correspondence Address: Jacobson Holman, Professional Limited Liability Company, 400 Seventh Street, N.W., Washington, DC, 20004-2218, US

(21) Appl. No.: 10/283,337

(22) Filed: Oct. 30, 2002

(51) Int. Cl. A23F 3/00

(52) U.S. Cl. 99/279

(57) ABSTRACT

Disclosed is an instant coffee-brewing container that comprises a cup cover, a dripper, a filter, and a coffee-ground bag, all being packed into a package container. The cup cover or dripper is detachably coupled to the top opening of a beverage cup so as to cover the top opening, and the cup cover has an upwardly-projected drinking port with a hole at the center or one side of the cup cover. The dripper has a recessed spillage prevention portion inclined downwardly to one side from a horizontal centerline passing through a center of a bottom surface of the dripper, and the dripper has a drinking port with a hole near the recessed spillage prevention portion.

The instant coffee-brewing container has the cup cover, or the dripper serving as a cup cover, thereby making it easy to drink the freshly brewed coffee during movement, as well as in places such as home, workplace, etc.

### BACKGROUND OF THE INVENTION

1. Field of the Invention

The present invention relates to an instant coffee-brewing container for preparing freshly brewed coffee, and more particularly to an instant coffee-brewing container for preparing freshly brewed coffee which allows easy drinking of the freshly brewed coffee even outdoors, as well as at home and office, and which is also improved in portability and convenience of use.

1. Description of the Related Art

Dried and roasted coffee beans are available on the market. In order to obtain a freshly brewed coffee, it is required for a user to personally grind the dried and roasted coffee beans and extract the brewed coffee from the ground beans.

Thus, a grinding and extracting device must be employed for the user to prepare the freshly brewed coffee. This is possible at places such as home and office, but not easy outdoors. Meanwhile, an instant coffee is currently on the market in a teabag form of coffee, sugar, and cream so as to be also used outdoors, improving the convenience of both use and drinking thereof. However, a more complicated configuration is needed to realize an instant freshly brewed coffee.

Several propositions to realize the instant freshly brewed coffee have been made in U.S. Pat. No. 5,913,964(Melton), U.S. Pat. No. 5,806,408(Debacker et al.), U.S. Pat. No. 5,243,164(Ericson et al.), U.S. Pat. No. 4,697,503(Okabe et al.), U.S. Pat. No. 370,141(J. Hobbsl), U.S. Pat. No. 396,685(J. D. Houck), U.S. Pat. No. 3,795,182(Van Damme), U.S. Pat. No. 3,083,101(J. Noury.), U.S. Pat. No. 3,579,351(H. Wege et al.), U.S. Pat. No. 2,743,664(S. Dale), and Japanese Unexamined Utility Publication No. 63-95528, etc.

The above-mentioned prior arts have a common object to resolve such a problem that the grinding and extraction device must be provided to enjoy the freshly brewed coffee, and therefore they provide an instant coffee brewer for drinking a freshly brewed coffee that enables easier drinking of the freshly brewed coffee outdoors as well as indoors, like the teabag-type instant coffee.

However, the instant coffee brewers of the prior arts mostly include a dripper, but not any means for preventing the spillage of a beverage, and thus have a problem that it is difficult to enjoy the freshly brewed coffee during movement.

In addition, the drippers described in the prior arts have a size that does not match that of a usual cup widely used at home, making it difficult to drip the brewed coffee into the cup, so that those configurations are inevitably limited only to use in a convenience store.

### SUMMARY OF THE INVENTION

Therefore, the present invention has been made in view of the above problems, and it is an object of the present invention to provide an instant coffee-brewing container for preparing freshly brewed coffee which makes drinking of the freshly brewed coffee easier during movement as well as at home.

It is another object of the present invention to provide an instant coffee-brewing container for preparing freshly brewed coffee that allows a drinker to prepare the freshly brewed coffee in various ways and drink it anywhere.

In accordance with one aspect of the present invention, the above and other objects can be accomplished by the provision of an instant coffee-brewing container comprising a cup cover, a dripper, a filter, and a coffee-ground bag, all being packed into a package container, the cup cover being detachably coupled to a top opening of a beverage cup so as to cover the top opening of the beverage cup, and the cup cover having an upwardly-projected drinking port at its center or its one side, the drinking port having a drinking hole.

In accordance with another aspect of the present invention, there is provided an instant coffee-brewing container comprising a dripper, a filter, and a coffee-ground bag, all being packed into a package container, the dripper having a recessed spillage prevention portion inclined downwardly to one side from a horizontal centerline passing through a center of a bottom surface of the dripper, the dripper having a drinking port with a hole near the recessed spillage prevention portion.

In accordance with yet another aspect of the present invention, there is provided an instant coffee-brewing container comprising a dripper, a filter, and a coffee-ground bag, all being packed into a package container, the dripper having a drinking port with a hole at a center of the dripper to receive a straw.

Preferably, the instant coffee-brewing container may further comprise a dripping ring coupled to a peripheral surface of the dripper and having such an outer width that the dripping ring may be laid across a top rim of a coffee cup.

The instant coffee-brewing container has the cup cover, or the dripper serving as a cup cover, thereby making it easy to drink the freshly brewed coffee during movement, as well as in places such as home, workplace, etc.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is an exploded-perspective view showing an instant coffee-brewing container for preparing freshly brewed coffee according to a first embodiment of the present invention;

FIG. 2 is a sectional view showing the instant coffee-brewing container of FIG. 1 when it is packed in a package B;

FIG. 3 is an exploded-perspective view showing an instant coffee-brewing container for preparing freshly brewed coffee according to a second embodiment of the present invention;

FIG. 4 is an exploded-perspective view showing an instant coffee-brewing container for preparing freshly brewed coffee according to a third embodiment of the present invention; and

FIGS. 5A to 5D are views showing the method of using an instant coffee-brewing container according to a preferable modification of the present invention, which is applicable to all three embodiments of the present invention.

FIG. 6 is another embodiment of dripper according to a preferable modification of the present invention, which is applicable to all three embodiments of the present invention.

### DESCRIPTION OF THE PREFERRED EMBODIMENTS

Hereinafter, referring to the drawings, a detailed description will be given of the construction and operation of various preferred embodiments, each having a common basic principle to achieve the objects of the present invention.

The instant coffee-brewing container S according to the present invention features improved portability and usability in the home, compared with the prior arts.

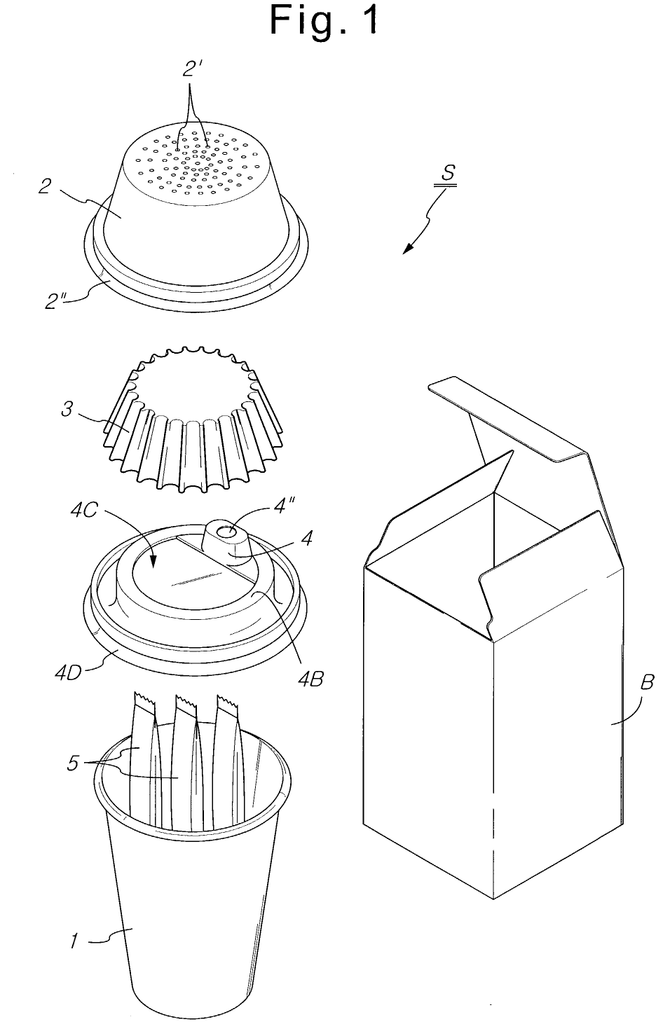

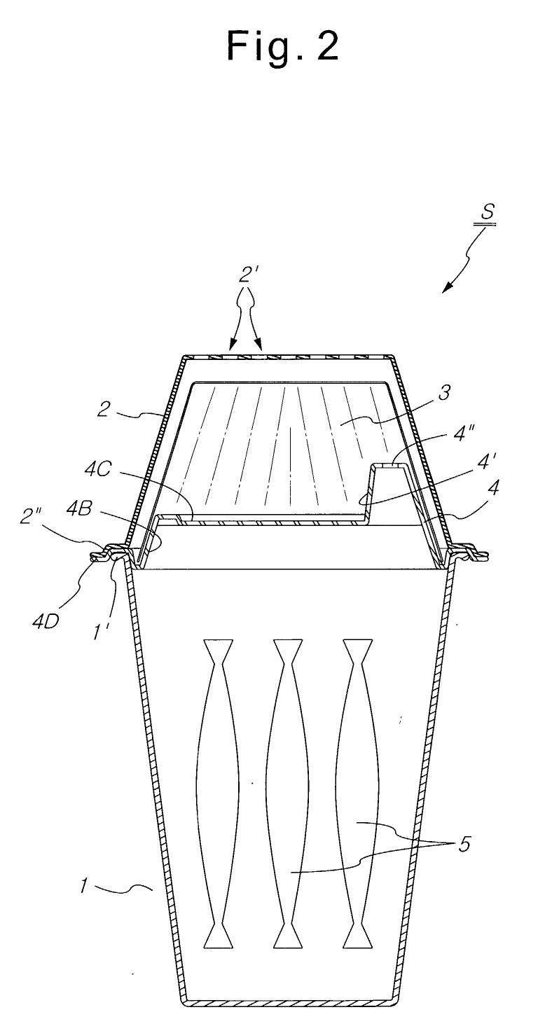

As shown in FIGS. 1 and 2, the instant coffee-brewing container S includes a beverage cup 1 made of paper, a synthetic resin, etc.; a dripper 2 made of a synthetic resin, etc.; a filter paper 3; a cup cover 4 for endowing the instant coffee-brewing container with portability; and a coffee-ground bag 5, a package container B of various designs and materials into which all elements mentioned above are combined together and packaged.

The package container B may be replaced with a vinyl container. The dripper 2 is in the form of a shallow cup and has a plurality of dripping holes 2′ at its lower portion and a first projection ring 2″ detachably coupled to the beverage cup 1 positioned below the dripper 2.

The beverage cup 1, the dripper 2, and the cup cover 4 are determined in size to be tightly combined with each other so that they may be used as one completely sealed body. FIG. 2 shows the instant coffee-brewing container S packaged in the package container B.

As shown in FIG. 1, the cup cover 4 is formed as a single body by injection molding, and includes an upward-projected cover body 4B, a second projection ring 4D that allows the cup cover 4 to be detachably coupled to the beverage cup 1, and a drinking port 4′ being projected upward from the center or one side of the cup cover 4 and having a drinking hole 4 at its top. The drinking port 4′ is provided to allow the user to drink the freshly brewed coffee with his or her mouth, and mainly to allow the user to drink a hot coffee with a straw not shown, as well as to avoid the spillage of coffee during movement. Preferably, an upper plate 4C of the cup cover 4 is in a recessed form.

It is preferable that an upper reinforcing ring 1 of the beverage cup 1 is detachably coupled to the second projection ring 4D, and the projection ring 4D is detachably coupled to the first projection ring 2 of the dripper 2 to form a watertight seal therebetween.

The instant coffee-brewing container has the same method of use as that of the prior art. That is, the package container B is first opened, and then the dripper 2 is coupled to the beverage cup 1. Next, the filter paper 3 is inserted into the dripper 2. Thereafter, coffee grounds inside the coffee-ground bag 5 are fed into the filter paper 3, and then hot water is poured thereinto so as to prepare the brewed coffee.

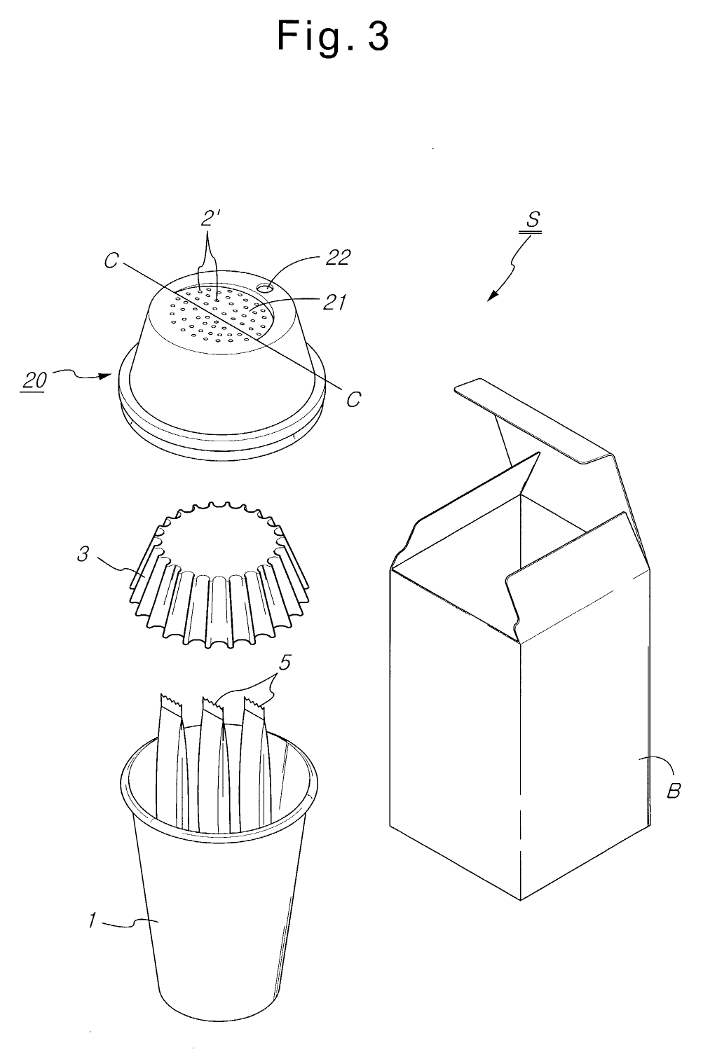

FIG. 3 is an exploded-perspective view showing an instant coffee-brewing container according to a second embodiment of the present invention. This embodiment is simpler in configuration, relative to the first embodiment, thereby maximizing the portability. That is, the cup cover 4 of FIG. 1 is removed. Instead, the dripper 20 has a recessed spillage prevention portion 21 that is inclined downwardly to one side from a horizontal centerline C passing through the center of the bottom surface of the dripper 20. The dripper 20 also has a drinking port 22 that has a hole near the recessed spillage prevention portion 21. After being used as a dripper, the dripper 20 is turned over and coupled to the beverage cup 1 to be used also as a cup cover during movement.

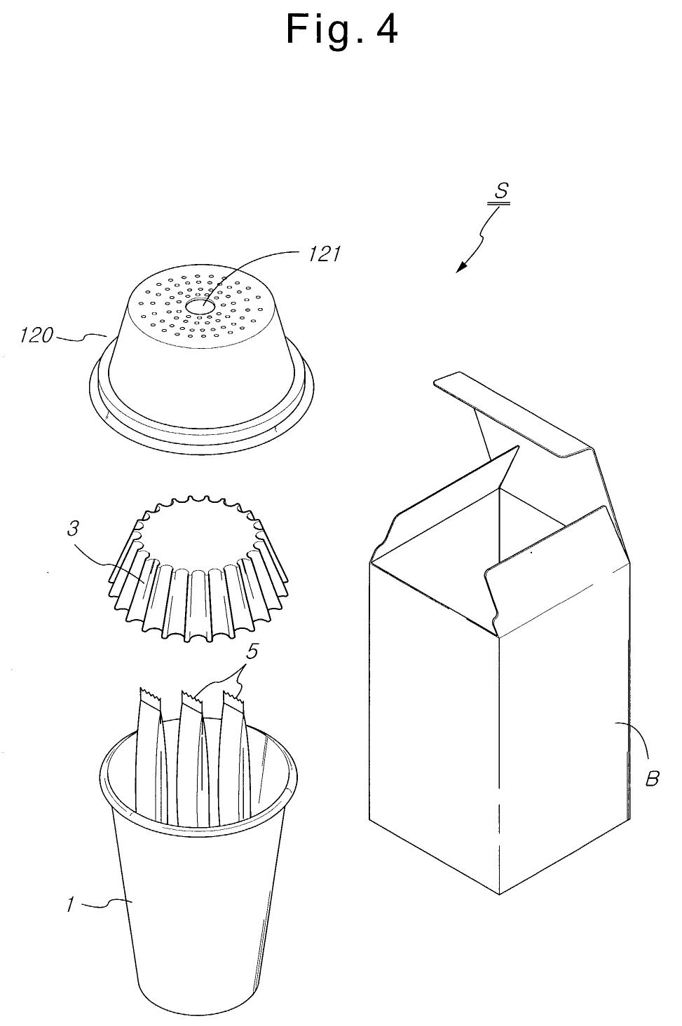

FIG. 4 is an exploded-perspective view showing an instant coffee-brewing container according to a third embodiment of the present invention. This embodiment features that the dripper has a drinking port 121 with a hole at the center of the bottom surface of the dripper 121, and it also functions as both a dripper and a cup cover.

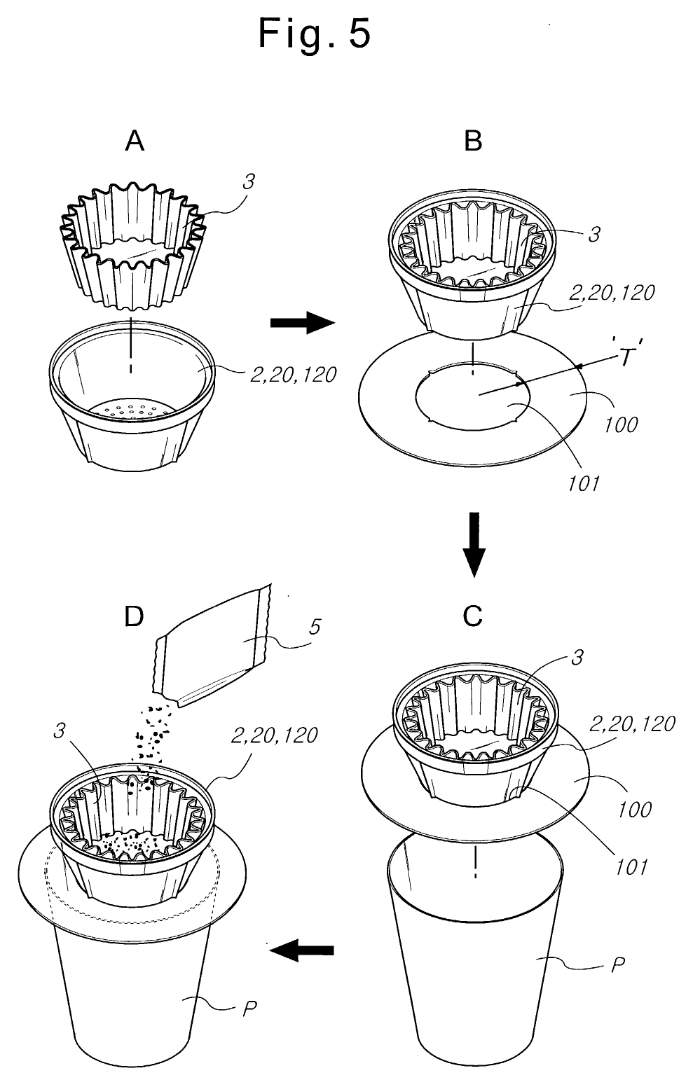

More preferably, the three embodiments further include, as shown in FIG. 5, a dripping ring 100 into which the dripper 2, 20, or 120 is fixedly inserted. Of course, the dripping ring 100 may be used or not, according to purposes of use.

The dripping ring 100 has a ring shape and is made of paper, a synthetic resin, etc. In addition, the dripping ring 100 has an insertion hole 101 of such a size that the dripper 2, 20, or 120 of upwardly increasing diameter is fixedly engaged with the dripping ring 100 when its lower half is inserted into the insertion hole 101. The dripping ring 100 preferably has such an outer width T that, as shown in FIG. 5D, it may be laid across the top rim of a various types of coffee cup P.

As mentioned above, the dripping ring permits the dripper 2, 20, or 120 to be laid across the top rim of the usual coffee cup P in various sizes, as well as across the beverage cup 1 packed in the package container B, in result, making its use easy even at home.

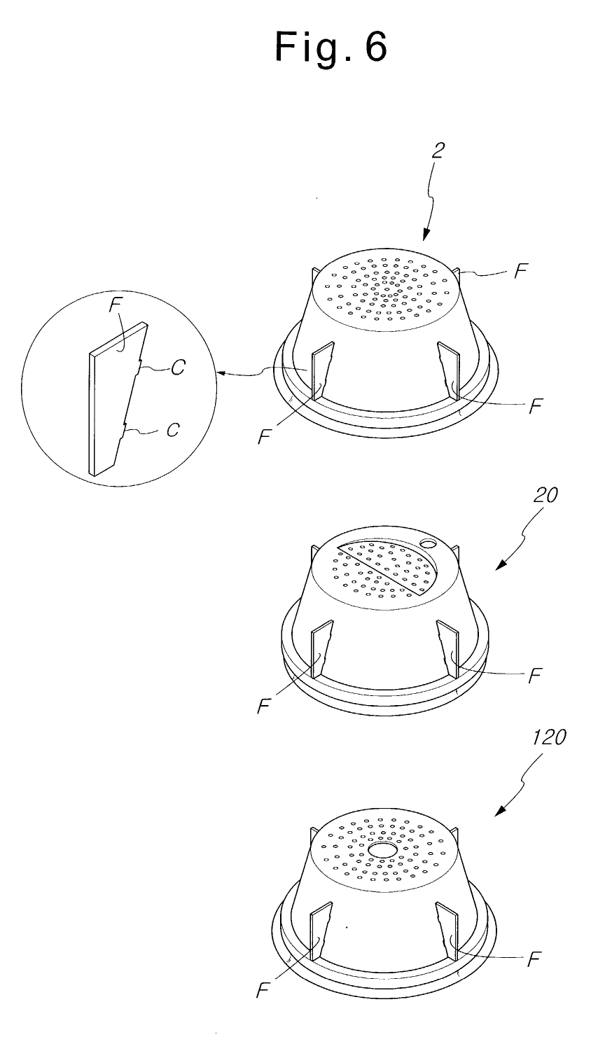

The same idea is adopted to the drippers 2, 20, 120 in other way as shown FIG. 6. The dripper 2, 20, 120 according to the above embodiment can have flips F partially connected to the outer peripheral side of dripper 2, 20, 120.

Flips F are easily torn away from the outer peripheral side of dripper 2, 20, 120 or folded down with fingers at the connected part C of flips F. These flips permit the dripper 2, 20, or 120 to be laid across the top rim of the usual coffee cup P in various sizes, as well as across the beverage cup 1 packed in the package container B, in result, making its use easy even at home. Users fold flips F down or tear flips F away from the outer peripheral side of dripper 2, 20, 120 if they do not necessitated.

As mentioned above, the instant coffee-brewing container according to the present invention has the cup cover 4, or the dripper 20 or 120 serving as a cup cover, thereby making it easy to drink the freshly brewed coffee during movement, as well as in places such as home, workplace, etc.

Although, the instant coffee-brewing container according to the present invention and mentioned in this invention refers only coffee, this invention can be adopted to several field of oriental teas, red tea and other teas made of any powder forms. With all the members of this invention, only coffee bean powder can be substituted with teas made of any powder forms.

And although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An instant coffee-brewing container comprising a cup cover, a dripper, a filter, and a coffee-ground bag, all being packed into a package container, the cup cover being detachably coupled to a top opening of a beverage cup so as to cover the top opening of the beverage cup, and the cup cover having an upwardly-projected drinking port at its center or its one side, the drinking port having a drinking hole.

2. An instant coffee-brewing container comprising a dripper, a filter, and a coffee-ground bag, all being packed into a package container, the dripper having a recessed spillage prevention portion inclined downwardly to one side from a horizontal centerline passing through a center of a bottom surface of the dripper, the dripper having a drinking port with a hole near the recessed spillage prevention portion.

3. An instant coffee-brewing container comprising a dripper, a filter, and a coffee-ground bag, all being packed into a package container, the dripper having a drinking port with a hole at a center of the dripper to receive a straw.

4. The instant coffee-brewing container according to claim 1, further comprising a dripping ring coupled to a peripheral surface of the dripper and having such an outer width that the dripping ring may be laid across a top rim of a coffee cup.

5. The instant coffee-brewing container according to claim 2, further comprising a dripping ring coupled to a peripheral surface of the dripper and having such an outer width that the dripping ring may be laid across a top rim of a coffee cup.

6. The instant coffee-brewing container according to claim 3, further comprising a dripping ring coupled to a peripheral surface of the dripper and having such an outer width that the dripping ring may be laid across a top rim of a coffee cup.

7. The instant coffee-brewing container according to claim 1, further comprising the dripper having flips F partially connected to be easily torn away from the outer peripheral side of dripper 2, 20, 120 or folded down with fingers at the connected part C of flips F.

8. The instant coffee-brewing container according to claim 2, further comprising the dripper having flips F partially connected to be easily torn away from the outer peripheral side of dripper 2, 20, 120 or folded down with fingers at the connected part C of flips F.

9. The instant coffee-brewing container according to claim 3, further comprising the dripper having flips F partially connected to be easily torn away from the outer peripheral side of dripper 2, 20, 120 or folded down with fingers at the connected part C of flips F.
